(19) United States
(12) Patent Application Publication
(10) Pub. No.: US 2004/0125017 A1
(43) Pub. Date: Jul. 1, 2004

(54) Compressed antenna in a volume

(76) Inventors: Robert Paul Garcia, San Jose, CA (US); Shu Li Wang, Redwood Shores, CA (US); Suresh Kumar Ramasamy, Redwood City, CA (US); Eduardo Camacho Lopez, Watsonville, CA (US)

Correspondence Address: David E. Lovejoy, 102 Reed Ranch Road, Tiburon, CA, 94920-2025, US

(21) Appl. No.: 10/330,376

(22) Filed: Dec. 27, 2002

(51) Int. Cl. H01Q 1/38

(52) U.S. Cl. 343/700 MS; 343/895; 343/702; 343/866; 343/741

(57) ABSTRACT

A compressed antenna in a volume, with one or more of the compressed antennas suitable for use in the front ends of small communications devices. The compressed antennas operate for exchanging energy in one or more bands of radiation frequencies. The antennas include one or more radiation elements formed of conducting electrically connected so as to exchange energy in one or more of the bands of the radiation frequencies. One or more of the radiation elements has segments three-dimensionally arrayed and compressed in a volume.

### BACKGROUND OF THE INVENTION

The present invention relates to the field of communication devices that communicate using radiation of electromagnetic energy and particularly relates to antennas and radio frequency (RF) front ends for such communication devices, particularly antennas for small communication devices carried by persons or communication devices otherwise benefitting from small-sized antennas and small-sized front ends.

Small communication devices include front-end RF components connected to base-band components (base components). The front-end components operate at RF frequencies and the base components operate at intermediate frequencies (IF) or other frequencies lower than RF frequencies. The RF front-end components for small devices have proved to be difficult to design and miniaturize. The antenna and other front-end components contribute a significant amount of the cost of small communication devices. The size of the antenna and its connection to the other RF components must be reduced in size in order to reduce the size of communication devices.

Communication devices that both transmit and receive with different transmit and receive bands typically use filters (duplexers, diplexers) to isolate the transmit and receive bands. Such communication devices typically employ broadband antennas that operate over frequency bands that are wider than the operating bands of interest and therefore filters are used to separate the receive (Rx) band and the transmit (Tx) band of a communication device. A communication device using transmit and receive bands for two-way communication is often referred to as a “single-band” communication device since the transmit and receive bands are usually close to each other within the frequency spectrum and are paired or otherwise related to each other for a common transmit/receive protocol. Dual-band communication devices use two pairs of transmit and receive bands, each pair for two-way communication. In multi-band communication devices, multiple pairs of transmit and receive bands are employed, each pair for two-way communication. In dual-band and other multi-band communication devices, filters or other mechanisms are needed to separate the multiple bands and to separate transmit and receive signals within each of the multiple bands. In standard designs, a Low Noise Amplifier (LNA) is included between the antenna and a mixer. The mixer converts between RF frequencies of the front-end components and lower frequencies of the base components.

The common frequency bands presently employed include GSM 900, GSM 1800, DCS 1800 and PCS 1900 where the frequency ranges are as follows:

| | Frequency Ranges |
|---|---|
| US Cell | 824-894 MHz |
| GSM 900 | 890-960 MHz |
| GSM 1800 | 1710-1880 MHz |
| GSM 1900 (PCS) | 1850-1990 MHz |

Communication Antennas Generally. In communication devices and other electronic devices, antennas are elements having the primary function of transferring energy to (in the receive mode) or from (in the transmit mode) the electronic device through radiation. Energy is transferred from the electronic device (in the transmit mode) into space or is transferred (in the receive mode) from space into the electronic device. A transmitting antenna is a structure that forms a transition between guided waves contained within the electronic device and space waves traveling in space external to the electronic device. The receiving antenna forms a transition between space waves traveling external to the electronic device and guided waves contained within the electronic device. Often the same antenna operates both to receive and transmit radiation energy.

Frequencies at which antennas radiate are resonant frequencies for the antenna. A resonant frequency, f, of an antenna can have many different values as a function, for example, of dielectric constant of material surrounding an antenna, the type of antenna, the geometry of the antenna and the speed of light.

In general, wave-length, λ, is given by λ=c/f=cT where c=velocity of light (=3×10⁸ meters/sec), f=frequency (cycles/sec), T 1/f=period (sec). Typically, the antenna dimensions such as antenna length, Aₜ, relate to the radiation wavelength λ of the antenna. The electrical impedance properties of an antenna are allocated between a radiation resistance, Rₜ, and an ohmic resistance, Rₒ. The higher the ratio of the radiation resistance, Rₜ, to the ohmic resistance, Rₒ the greater the radiation efficiency of the antenna.

Antennas are frequently analyzed with respect to the near field and the far field where the far field is at locations of space points P where the amplitude relationships of the fields approach a fixed relationship and the relative angular distribution of the field becomes independent of the distance from the antenna.

Antenna Types. A number of different antenna types are well known and include, for example, loop antennas, small loop antennas, dipole antennas, stub antennas, conical antennas, helical antennas and spiral antennas. Such antenna types have often been based on simple geometric shapes. For example, antenna designs have been based on lines, planes, circles, triangles, squares, ellipses, rectangles, hemispheres and paraboloids. The two most basic types of electromagnetic field radiators are the magnetic dipole and the electric dipole. Small antennas, including loop antennas, often have the property that radiation resistance, Rₜ, of the antenna decreases sharply when the antenna length is shortened.

An antenna radiates when the impedance of the antenna approaches being purely resistive (the reactive component approaches 0). Impedance is a complex number consisting of real resistance and imaginary reactance components. A matching network can be used to force resonance by eliminating reactive components of impedance for particular frequencies.

The RF front end of a communication device that operates to both transmit and receive signals includes antenna, filter, amplifier and mixer components that have a receiver path and a transmitter path. The receiver path operates to receive the radiation through the antenna. The antenna is matched at its output port to a standard impedance such as 50 ohms. The antenna captures the radiation signal from the air and transfers it as an electronic signal to a transmission line at the antennas output port. The electronic signal from the antenna enters the filter which has an input port that has also been matched to the standard impedance. The function of the filter is to remove unwanted interference and separate the receive signal from the transmit signal. The filter typically has an output port matched to the standard impedance. After the filter, the receive signal travels to a low noise amplifier (LNA) which similarly has input and output ports matched to the standard impedance, 50 ohms in the assumed example. The LNA boosts the signal to a level large enough so that other energy leaking into the transmission line will not significantly distort the receive signal. After the LNA, the receive signal is filtered with a high performance filter which has input and output ports matched to the standard impedance. After the high performance filter, the receive signal is converted to a lower frequency (intermediate frequency, IF) by a mixer which typically has an input port matched to the standard impedance.

The transmit path is much the same as the receive path. The lower frequency transmission signal from the base components is converted to an RF signal in the mixer and leaves the mixer which has a standard impedance output (for example, 50 ohms in the present example). The transmission signal from the mixer is “cleaned up” by a high performance filter which similarly has input and output ports matched to the standard impedance. The transmission signal is then buffered in a buffer amplifier and amplified in a power amplifier where the amplifiers are connected together with standard impedance lines, 50 ohms in the present example. The transmission signal is then connected to a filter, with input and output ports matched to the standard impedance. The filter functions to remove the remnant noise introduced by the receive signal. The filter output is matched to the standard impedance and connects to the antenna which has an input impedance matched to the standard impedance.

As described above, the antenna, filter, amplifier and mixer components that form the RF front end of a small communication device each have ports that are connected together from component port to component port to form a transmission path and a receive path. Each port of a component is sometimes called a junction. For a standard design, the junction properties of each component in the transmission path and in the receive path are matched to standard parameters at each junction, and specifically are matched to a standard junction impedance such as 50 ohms. In addition to impedance values, each junction is also definable by additional parameters including scattering matrix values and transmittance matrix values. The junction impedance values, scattering matrix values and transmittance matrix values are mathematically related so that measurement or other determination of one value allows the calculation of the others.

Typical front-end designs place constraints upon the physical junctions of each component and treat each component as a discrete entity which is designed in many respects independently of the designs of other components provided that the standard matching junction parameter values are maintained. While the discrete nature of components with standard junction parameters tends to simplify the design process, the design of each junction to satisfy standard parameter values (for example, 50 ohms junction impedance) places limitations upon the overall front-end design.

While many parameters maybe tuned and optimized in RF front ends, the antenna is a critical part of the design. In order to miniaturize the RF front end, miniaturization of the antenna is important to achieve small size. In the prior applications entitled ARRAYED-SEGMENT LOOP ANTENNA (SC/Ser. No. 09/738,906) and LOOP ANTENNA WITH RADIATION AND REFERENCE LOOPS (SC/Ser. No.: 09/815,928) assigned to the same assignee as the present application, compressed antennas were shown to render good performance with small sizes. Those antennas were compressed primarily on a two-dimensional basis by having multiple segments connected in snowflake, irregular and other compressed two-dimensional patterns. Some of those compressed antennas have relatively large “footprints,” that is, the size of the antennas on substrates, circuit boards or other planes is larger than is desired for high compression.

In consideration of the above background, there is a need for improved antennas having smaller “footprints” for miniaturizing the RF front ends of communication devices.

### SUMMARY

The present invention is a compressed antenna in a volume. One or more of the compressed antennas are suitable for use in the front ends of small communications devices. The compressed antennas operate for exchanging energy in one or more bands of radiation frequencies. The antennas include one or more radiation elements formed of conducting electrically connected so as to exchange energy in one or more of the bands of the radiation frequencies. One or more of the radiation elements has segments three-dimensionally arrayed and compressed in a volume.

In one embodiment, the compressed antenna has the radiation elements deployed on a flexible substrate and the elements and the substrate are folded to fit within a volume.

In one embodiment, the antenna has radiation elements three-dimensionally arrayed in a volume arrayed to form a three-dimensional loop.

In one embodiment, the radiation element includes one or more connection pads for electrical connection to RF components of the communication device where the connection pads are suitable for surface mounting to a circuit board.

The foregoing and other objects, features and advantages of the invention will be apparent from the following detailed description in conjunction with the drawings.

### BRIEF DESCRIPTION OF THE DRAWINGS

FIG. 1 depicts a schematic top view of one embodiment of an unfolded compressed antenna lying in a base plane deployed on a flexible substrate.

FIG. 2 depicts a schematic top view of the compressed antenna of FIG. 1 folded on lines into a volume.

FIG. 3 depicts a schematic front view of the compressed antenna of FIG. 1 folded into a volume as shown in FIG. 2.

FIG. 4 depicts a volume for containing the compressed antenna of FIG. 3.

FIG. 5 depicts a schematic top view of another embodiment of the unfolded compressed antenna of FIG. 1 deployed on a flexible substrate.

FIG. 6 depicts a schematic front view of the compressed antenna of FIG. 5 folded in regions into a volume.

FIG. 7 depicts a schematic front view of a compressed antenna folded as in FIG. 6 with dielectric spacers separating folded layers.

FIG. 8 depicts a schematic top view of a compressed antenna rolled into a volume.

FIG. 9 depicts a schematic top view of another embodiment of an unfolded compressed antenna lying in a base plane deployed on a flexible substrate having an unfolded Origami pattern.

FIG. 10 depicts a schematic top view of the compressed antenna of FIG. 8 folded along lines of the Origami pattern of FIG. 8.

FIG. 11 depicts a schematic front view of the compressed antenna of FIG. 8 folded into a volume as shown in FIG. 10.

FIG. 12 depicts a schematic isometric view of the compressed antenna of FIG. 8 partially folded into a volume as shown in FIG. 10 and FIG. 10.

FIG. 13 depicts a schematic top view of another embodiment of an unfolded compressed antenna lying in a base plane and deployed on a flexible substrate.

FIG. 14 depicts a schematic front view of the antenna of FIG. 13 rolled for compression into a volume.

FIG. 15 depicts a schematic top view of another embodiment of an unfolded compressed antenna.

FIG. 16 depicts a top view of a flip-top phone communication device using antennas in accordance with the present invention.

FIG. 17 depicts an end view of the communication device of FIG. 16 cut away to reveal the antennas.

FIG. 18 depicts a top view of the communication device of FIG. 16 cut away to reveal the antennas.

FIG. 19 depicts a top view of another communication device cut away to reveal the antennas inside.

FIG. 20 depicts an end sectional view of the communication device of FIG. 19 that reveals an antenna.

FIG. 21 depicts a two-dimensional representation of the field pattern of the antenna of FIG. 13 for the US PCS receive Rₓ band.

FIG. 22 depicts a two-dimensional representation of the field pattern of the antenna of FIG. 14 for the US PCS transmit Tₓ band.

FIG. 23 depicts a schematic view of a small communication device with RF front-end functions including separate transmit and receive antennas and other RF function components and including lower frequency base components.

FIG. 24 depicts a schematic view of a small communication device with RF front-end functions including a common antenna for transmitting and receiving and other RF function components for transmitting and receiving and including lower frequency base components.

### DETAILED DESCRIPTION

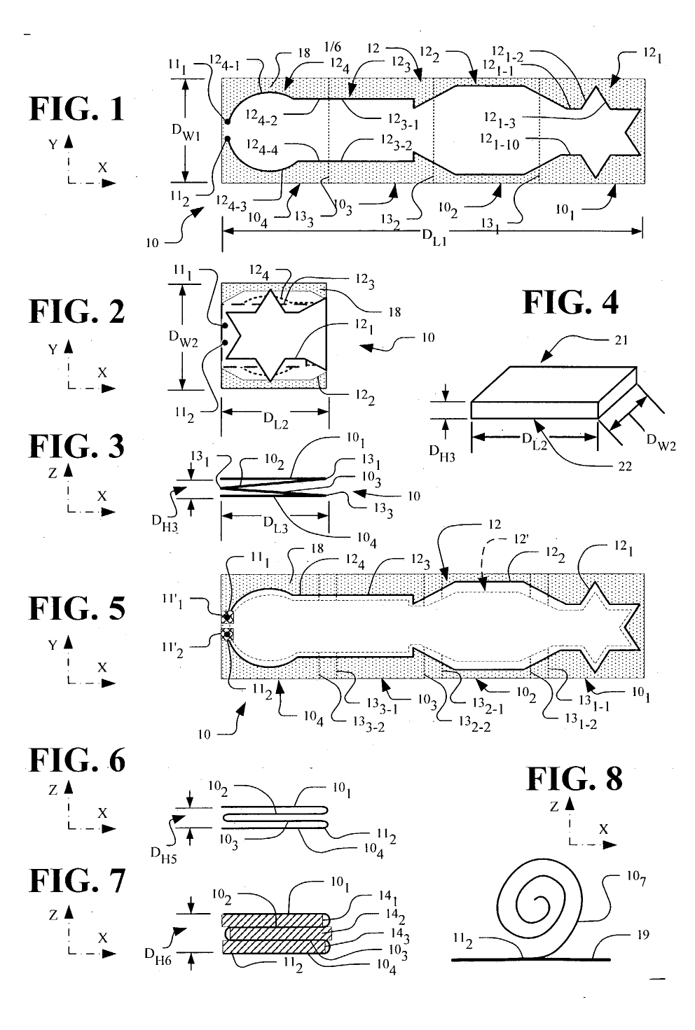

FIG. 1 depicts a schematic top view of one embodiment of an unfolded antenna 10 formed of a conductor 12 lying in a base plane (the plane of the drawing) deployed on a flexible substrate 18. The antenna 10 is formed of regions 10₁, 10₂, 10₃ and 10₄ where region 10₁ connects to region 10₂, region 10₂ connects to region 10₃ and region 10₃ connects to region 10₄. The antenna conductor 12 is formed of sections 12₁, 12₂, 12₃ and 12₄, each formed of conducting segments, deployed in regions 10₁, 10₂, 10₃ and 10₄, respectively. The section 12₁ connects to section 12₂, section 12₂ connects to section 12₃ and section 12₃ connects to section 12₄. The section 12₄ terminates in termination end 11₁ and connection pad 11₂ that are fabricated on substrate 18. The antenna conductor 12 and sections 12₁, 12₂, 12₃ and 12₄ form a loop between termination end 11₁ and connection pad 11₂. The sections 12₁, 12₂, 12₃ and 12₄ are deployed on the substrate 18 in the regions 10₁, 10₂, 10₃ and 10₄, respectively. The overall outside dimensions, D_{W1} and D_{L1}, of the antenna 10 are approximately 10 mm and 26 mm, respectively. The antenna conductor 12 and substrate 18 are intended to be folded into a volume along the folding lines 13₁, 13₂ and 13₃.

FIG. 2 depicts a schematic top view of the antenna 10, including the antenna conductor 12 on substrate 18 as shown in FIG. 1, folded into a volume. The view in FIG. 2 is cutaway to show the sections 12₁, 12₂, 12₃ and 12₄ superimposed and terminating in the connection pads 11-1 and 11-2 at the bottom of the volume. In FIG. 2, the outside dimensions, D_{W2} and D_{L2}, of the antenna 10 are approximately 10 mm and 10 mm, respectively. Accordingly, the projection of the antenna onto a reference base plane (the plane of the drawing) at the bottom of the volume has been reduced from 10 mm×26 mm in FIG. 1 to 10 mm×10 mm in FIG. 2. In FIG. 2, the segments of section 12₃ are superimposed over the segments of section 12₁. The segments of section 12₂ are superimposed over the segments of section 12₃ and section 12₄. The segments of section 12₁ are superimposed over the segments of section 12₂, section 12₃ and section 12₄. By way of example and as shown in FIG. 1, section 12₁ includes conducting segments 12₁₋₁, 12₁₋₂, 12₁₋₃, . . . , 12₁₋₁₀. Similarly, section 12₃ includes conducting segments 12₃₋₁ and 12₃₋₂ among others. Also, section 12₄ includes segments 12₄₋₁, 12₄₋₂, 12₄₋₃ and 12₄₋₄. When antenna 10 is folded as in FIG. 2, the segments 12₁₋₁, 12₁₋₂, 12₁₋₃, . . . , 12₁₋₁₀ are superimposed over the segment 12₃₋₁ and 12₃₋₂ and over the segments 12₄₋₁, 12₄₋₂, 12₄₋₃ and 12₄₋₄ among others. Also, the projections onto the base plane of the segments 12₁₋₁, 12₁₋₂, 12₁₋₃, . . . , 12₁₋₁₀ and of the segments 12₃₋₁ and 12₃₋₂ overlap. In FIG. 2, the base plane is the region 10₄ supporting the section 12₄ and including segments 12₄₋₁, 12₄₋₂, 12₄₋₃ and 12₄₋₄.

FIG. 3 depicts a schematic front view of the antenna 10 of FIG. 1 compressed as shown in FIG. 2. The view of FIG. 3 shows the regions 10₁, 10₂, 10₃ and 10₄ folded along the folding lines 13₁, 13₂ and 13₃ of FIG. 1. The height of the antenna 10 above the base plane is D_{H3} so that the volume of antenna 10 is D_{W2}×D_{L3}×D_{H3} where D_{W2} equals D_{W1} and D_{L3} equals D_{L2}.

FIG. 4 depicts a volume 21 for containing the compressed antenna 10 of FIG. 3. The volume 21 measures D_{H3}×D_{L2}×D_{WZ}. In one embodiment, D_{W2} equals D_{L2} equals about 1 cm and D_{H3} is less than ½ cm. The volume 21 has a base plane 22 on the bottom which measures D_{L2}×D_{WZ}.

FIG. 5 depicts a schematic top view of another embodiment of an unfolded antenna 10, like antenna 10 of FIG. 1, formed of a conductor 12 lying in a base plane (the plane of the drawing) deployed on a flexible substrate 18. The antenna 10 is formed of regions 10₁, 10₂, 10₃ and 10₄ where region 10₁ connects to region 10₂, region 10₂ connects to region 10₃ and region 10₃ connects to region 10₄. The antenna conductor 12 is formed of sections 12₁, 12₂, 12₃ and 12₄, each formed of conducting segments, deployed in regions 10₁, 10₂, 10₃ and 10₄, respectively. The section 12₁ connects to section 12₂, section 12₂ connects to section 12₃ and section 12₃ connects to section 12₄. The section 12₄ connects to termination end 11₁ and connection pad 11₂. The antenna conductor 12 and regions 12₁, 12₂, 12₃ and 12₄ form a loop between termination end 11₁ and connection pad 11₂. The termination end 11₁ and connection pad 11₂ are relatively small and include solder bumps in one embodiment. In another embodiment, the termination end 11₁ and connection pad 11₂ are expanded to the pads 11′₁ and 11′₂ which are larger to assist in registration using “pick and place” component mounting technology. The regions 12₁, 12₂, 12₃ and 12₄ are deployed on the substrate 18 in the regions 10₁, 10₂, 10₃ and 10₄, respectively. The overall outside dimensions of the antenna 10 are approximately 10 mm. The antenna conductor 12 and substrate 18 are intended to be folded into a volume along the regions between folding lines 13₁₋₁, and 13₁₋₂, 13₂₋₁, and 13₂₋₂ and 13₃₋₁ and 13₃₋₂.

FIG. 6 depicts a schematic front view of the antenna 10 of FIG. 5 compressed by folding. The view of FIG. 6 shows the regions 10₁, 10₂, 10₃ and 10₄ folded along the regions between the folding lines 13₁₋₁ and 13₁₋₂, 13₂₋₁ and 13₂₋₂ and 13₃₋₁ and 13₃₋₂ of FIG. 5.

In FIG. 1 and FIG. 5, as compressed in FIG. 6 or FIG. 7, the radiating element 12 is formed of sections 12₁, 12₂, 12₃ and 12₄ on the same side of the substrate 18. In a further embodiment, the substrate is formed with radiating element 12 on one side of substrate 18 and with another radiating element 12 of the same shape and size on the opposite side of substrate 18. In such embodiment, the connection points 11₁ and 11₂ of FIG. 5 serve as through-layer connections for connecting the radiating elements 12 and 12₁ in common. Alternatively, one of the elements, 12′ or example, on the bottom side can be of different size or shape and can or cannot be connected in common with the radiating element 12 on the top side of substrate 18.

In the FIG. 5 alternate embodiment as compressed like in FIG. 5 or FIG. 7, the radiating element 12′ is about the same size and shape as the radiating element 12 except that the conductor width is slightly greater as indicated by the broken line 12′ within 12. While the alternate embodiment of FIG. 5 deploys radiating elements on top and bottom sides of the same substrate, FIG. 5 can also be constructed using different substrates. For example, the FIG. 1 embodiment is deployed twice with one layer superimposed on a second duplicate layer where the layers have the same or different size and shape radiating elements.

FIG. 7 depicts a schematic front view of the antenna 10 of FIG. 5 compressed by folding. The view of FIG. 3 shows the regions 10₁, 10₂, 10₃ and 10₄ folded generally along the regions between the folding lines 13₁₋₁ and 13₁₋₂, 13₂₋₁ and 13₂₋₂ and 13₃₋₁ and 13₃₋₂ of FIG. 5. The regions 10₁, 10₂, 10₃ and 10₄ are separated by dielectric spacers 14₁, 14₂ and 14₃ with spacer 14₁ between regions 10₁ and 10₂, with spacer 14₂ between regions 10₂ and 10₃, and with spacer 14₃ between regions 10₃ and 10₄.

FIG. 8 depicts a schematic top view of antenna 10₇, similar to the antenna 10 of FIG. 1 or FIG. 5, that has been compressed by rolling into a helical shape. The contacts 11-2 appear at the bottom on a base plane 19 and hence are available for solder, or other connection, to a circuit board in a communication device such as a cell phone. The antenna 10₇ fits within a volume that has a projection of an area on the base plane 19 that is much smaller than the area of the antenna 10 of FIG. 5.

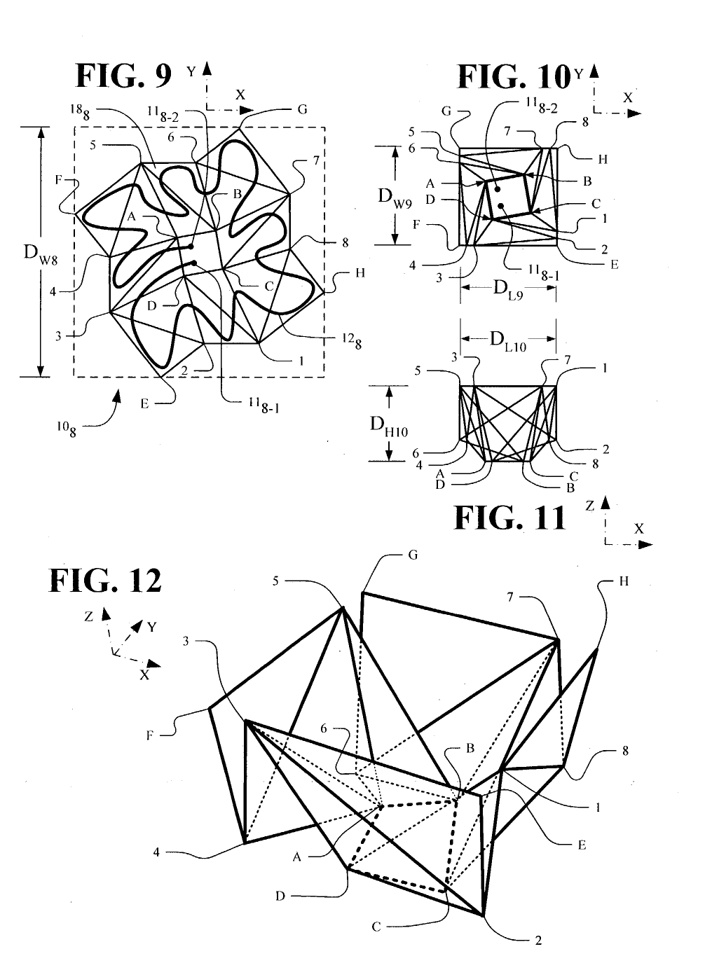

FIG. 9 depicts a schematic top view of another embodiment of an unfolded antenna 10₈ lying in a base plane having a conductor loop 12₈ deployed on a flexible substrate 18₈ having an Origami pattern. The conductor loop 12₈ has connection pads 11₈₋₁ and 11₈₋₂ on the base plane within the square ABCD. The Origami pattern is defined by the eight primary nodes 1, 2, . . . , 8 and the eight secondary nodes A, B, . . . , H with fold lines connecting between primary nodes, connecting between primary and secondary nodes and connecting between secondary nodes. The unfolded Origami pattern of FIG. 8 fits within an area of a square having side dimensions D_{W8} and hence the Origami pattern fits within a projection area on the base plane equal to (D_{W8})². The substrate 18₈ is flexible for folding and supports the radiation element 12₈ that terminates in connection pads 11₈₋₁ and 11₈₋₂.

FIG. 10 depicts a schematic top view of the embodiment of FIG. 9 antenna folded, compressed and lying in a volume defined by the folded Origami pattern. The Origami pattern in FIG. 10, is defined as in FIG. 9, by the eight primary nodes 1, 2, . . . , 8 and the eight secondary nodes A, B, . . . , H with fold lines connecting between primary nodes, connecting between primary and secondary nodes and connecting between secondary nodes. The folded Origami pattern of FIG. 10 fits within an area of a square having a side dimension D_{W9} and hence the Origami pattern of FIG. 10 has a projection area on the plane of the pattern equal to (D_{W9})². The projection area, (D_{W9})², of the compressed Origami pattern of FIG. 10 is about seven times smaller than the projection area, (D_{W8})², of the uncompressed Origami pattern of FIG. 9. The substrate 18₈ is flexible for folding and supports the radiation element 12₈ that terminates in connection pads 11₈₋₁ and 11₈₋₂.

FIG. 11 depicts a schematic front view of the folded compressed antenna of FIG. 10. The Origami pattern in FIG. 1I is defined as in FIG. 9 by the eight primary nodes 1, 2, . . . , 8 and the eight secondary nodes A, B, . . . , H with fold lines connecting between primary nodes, connecting between primary and secondary nodes and connecting between secondary nodes. The folded Origami pattern of FIG. 1I has a vertical dimension D_{H10} and has a base plane area of D_{W9}×DL₉. The volume of the compressed Origami pattern of FIG. 11 is {(D_{W9})²×D_{H10}} since D_{W9} equals D_{L9}.

FIG. 12 depicts a schematic isometric view of the compressed antenna of FIG. 9 partially folded into a volume as shown in FIG. 10 and FIG. 10. The Origami pattern in FIG. 12 is defined as in FIG. 9 through FIG. 11, by the eight primary nodes 1, 2, . . . , 8 and the eight secondary nodes A, B, . . . , H with fold lines connecting between primary nodes, connecting between primary and secondary nodes and connecting between secondary nodes.

FIG. 13 depicts a schematic top view of another embodiment of an unfolded antenna 10₁₂ having an irregular radiation element 30, formed of conducting segments, lying in a base plane and deployed on a flexible substrate 31. The substrate 31 is in two parts, one part 31₁ under the transmission line 32 and the other part 31₂ under the radiation element 30. The substrate 31 supports a transmission line 32, including parallel strips 32₁ and 32₂, connecting in series with the radiation element 30 with transmission line 32 so that radiation element 30 forms a loop antenna connected to a transmission line. The antenna 10₁₂ has overall outside dimensions, D_{W12} and D_{L12}, where the transmission line length is D_{L-T} and the uncompressed antenna radiation element 30 length is D_{L-C}. The antenna conductor 30 and substrate 31₂ are intended to be rolled into a volume. The substrate 31 includes an extension 31_{T} for insertion into a slot 31_{S} when rolled up. The antenna 10₁₂ is designed for the US PCS receive band. Typically, the transmission 32 line is deployed directly on a printed circuit board of a communication device.

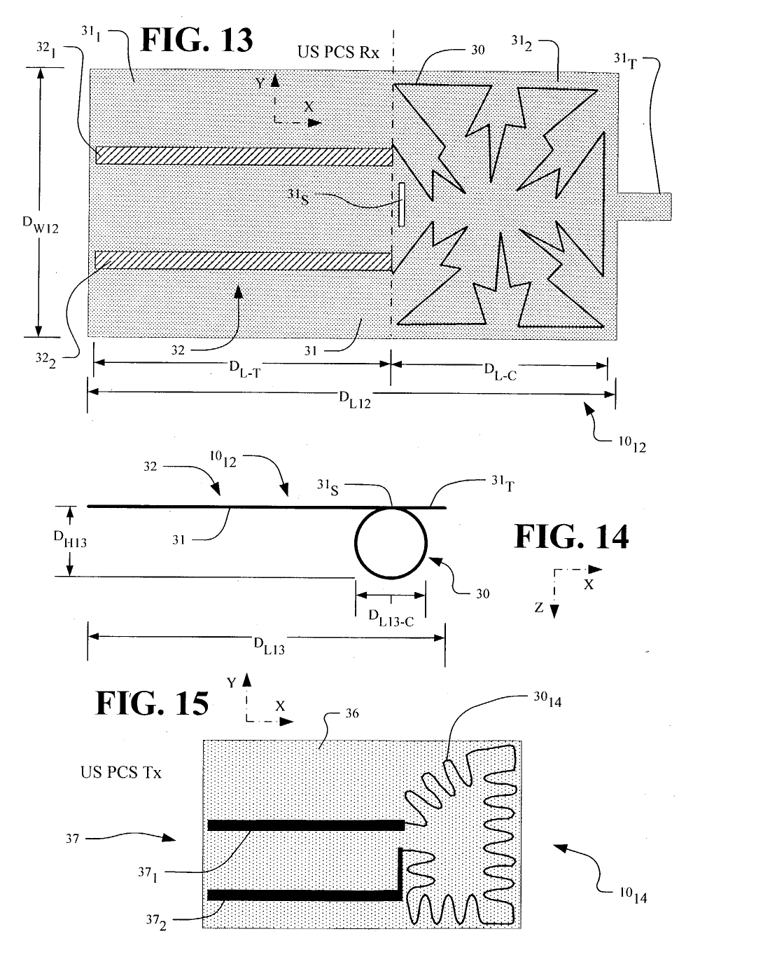

FIG. 14 depicts a schematic front view of the antenna 10₁₂ of FIG. 13 rolled-up (“folded”) into the compressed state. The antenna 10₁₂ in FIG. 14 has outside dimensions, D_{H13} and D_{L13}, where the compressed antenna radiation element 30 length is D_{L13-C}. The substrate 31 includes the extension 31_{T} inserted into the slot 31_{S}. The length of the radiation element 30, D_{L13-C}, in FIG. 14 is about one-third the uncompressed length D_{L-C} in FIG. 13 and hence compressing the antenna 10₁₂ by rolling into a volume reduces the projection the projection of the antenna 10₁₂ onto the base plane of the communication device.

FIG. 15 depicts a schematic top view of another embodiment of a compressed antenna 10₁₄ having an irregular radiation element 30₁₄, formed of conducting segments, lying in a plane and deployed on a substrate 36. The substrate 36 supports a transmission line 37, including parallel strips 37₁ and 37₂, connecting in series with the radiation element 30₁₄ so that radiation element 30₁₄ and transmission line 37 form a loop antenna connected to a transmission line. The antenna 10₁₄ is designed for the US PCS transmit band.

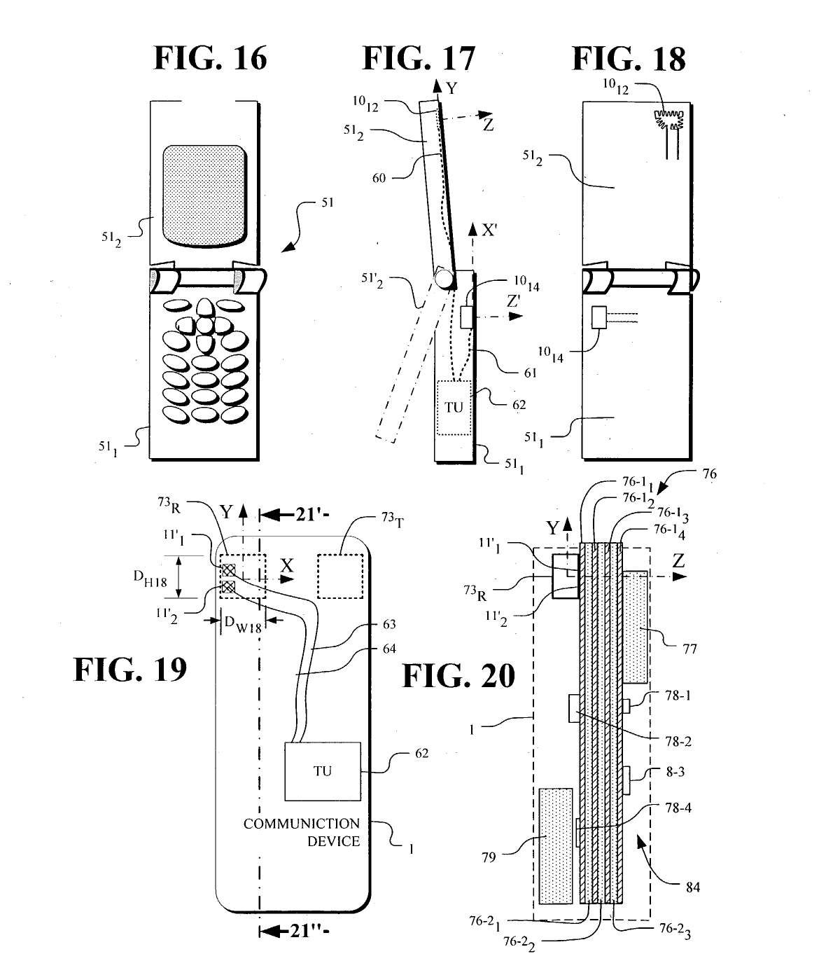

In FIG. 16, a top view is shown of communication device 51. The communication device 51 is a cell phone, pager or other similar communication device that can be used in close proximity to people with antennas of the present invention. The communication device 51 includes a flip portion 51₂ shown in the open position and includes a base portion 51₁. The communication device 51 includes antenna regions allocated for antennas like those shown in FIG. 13 and FIG. 15, for example, which receive and transmit. In one embodiment, the receive antenna is located in the base portion 51₁ and the transmit antenna is located in the flip portion 51₂. In FIG. 16, the antenna volumes are small so as to fit within the base and flip portions of the device 51.

In FIG. 13 and FIG. 15, the radiating elements 30 and 30₁₄ are formed of segments arrayed in multiple divergent directions not parallel to an orthogonal coordinate system so as to provide a long antenna electrical length while permitting the overall outside dimensions of the antenna to fit within a small antenna volume. The segments of antenna 30 include segments 30-1, 30-2, . . . , 30-70. The segments of antenna 30₁₄ include segments 30₁₄-1, 30₁₄-2, . . . , and so on. In FIG. 13 and FIG. 14, the radiation element 30 has an irregular shape and the segments 30-1, 30-2, . . . , 30-70 are arrayed in FIG. 14 in an irregular three-dimensional compressed pattern.

In FIG. 17, the communication device 51 of FIG. 16 is shown in a partially-sectioned end view to reveal the internal antennas 10₁₂ and 10₁₄. The communication device 51 includes a flip portion 51₂ shown solid in the open position and shown as 51′₂ in broken-line representing a near-closed position. The antennas 10₁₂ and 10₁₄ are electrically connected by cables or other conductors 60 and 61, respectively, to the transceiver unit (TU) 62 which processes the transmit and receive signals for antennas 10₁₂ and 10₁₄.

In FIG. 18, the communication device 51 of FIG. 16 is shown in a partially-removed top view to reveal the antennas 10₁₂ and 10₁₄.

In FIG. 19, communication device 1 is a cell phone, pager or other similar communication device that can be used in close proximity to people with antennas of the present invention. The communication device 1 includes antenna areas allocated for antennas 73_{R} and 73_{T} which receive and transmit, respectively, radio wave radiation for the communication device 1. In FIG. 19, the antenna areas have widths D_{W18} and heights D_{H18}. The connection pads 11′₁ and 11′₂ are large enough to assist in registration using “pick and place” component mounting technology. A section line 6′-6″ extends from top to bottom of the communication device. The communication device 1 is typically a mobile telephone of small volume, for example, of approximately 4 inches by 2 inches by 1 inch, or smaller, and the antennas, such as described in the present invention, readily fit within such small volume.

In FIG. 19, the antenna 73_{R} is typically a compressed antenna that lies in an XYZ-volume. Such antennas operate in allocated frequency spectrums around the world including those of North America, South America, Europe, Asia and Australia. The cellular frequencies are used when the communication device 1 is a mobile phone, PDA, portable computer, telemetering equipment or other wireless device. The antennas operate to transmit and/or receive in allocated frequency bands, for example, bands within the range from 800 MHz to 2500 MHz. In FIG. 19, antenna 73_{R} includes connections 63 and 64 connecting from connection pads 11′₁ and 11′₂ to the transceiver unit 62.

In FIG. 20, the communication device 1 of FIG. 19 is shown in a schematic, cross-sectional, end view taken along the section line 6′-6″ of FIG. 19. In FIG. 20, a circuit board 76 includes, by way of example, an outer conducting layer 76-1₁, internal conducting layers 76-1₂ and 76-1₃, internal insulating layers 76-2₁, 76-2₂ and 76-2₃, and another outer conducting layer 76-1₄. In one example, the layer 76-1₁ is a ground plane and the layer 76-1₂ is a power supply plane. The printed circuit board 76 supports the electronic components associated with the communication device 1 including a display 77 and miscellaneous components 78-1, 78-2, 78-3 and 78-4 which are shown as typical. Communication device 1 also includes a battery 79. The antennas 73_{5R} and 73_{5T} are mounted or otherwise coupled to the printed circuit board 76 by solder or other convenient connection means.

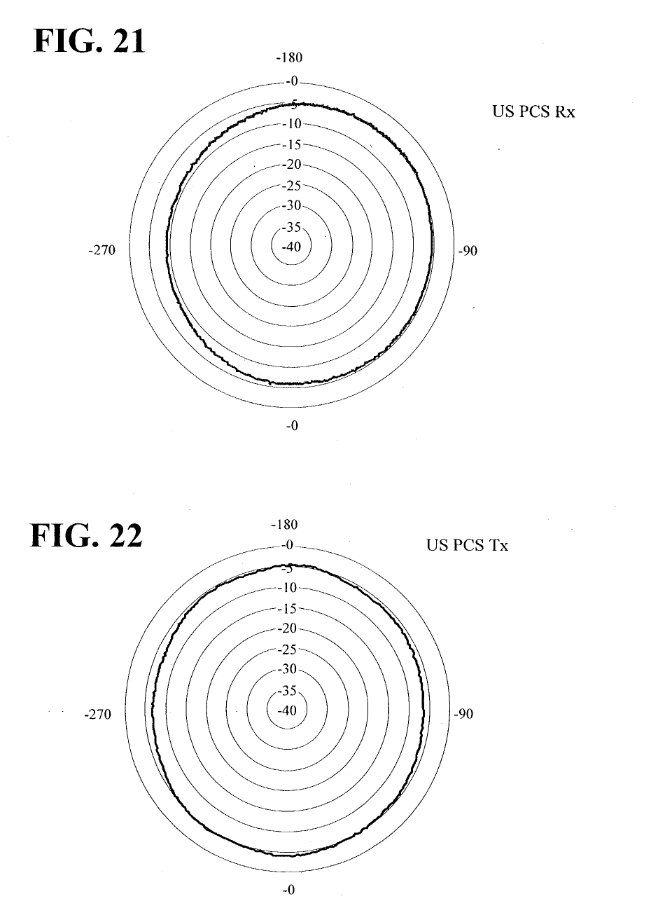

FIG. 21 depicts a two-dimensional representation of the average field pattern of the antenna structure of FIG. 3 for the US PCS Rx band. The average is taken for the frequencies 1850 MHz, 1910 MHz and 1990 MHz, none of which have a large variance from the average.

FIG. 22 depicts a two-dimensional representation of the average field pattern of the antenna structure of FIG. 15 for the US PCS Tx band. The average is taken for the frequencies 1850 MHz, 1910 MHz and 1990 MHz, none of which have a large variance from the average.

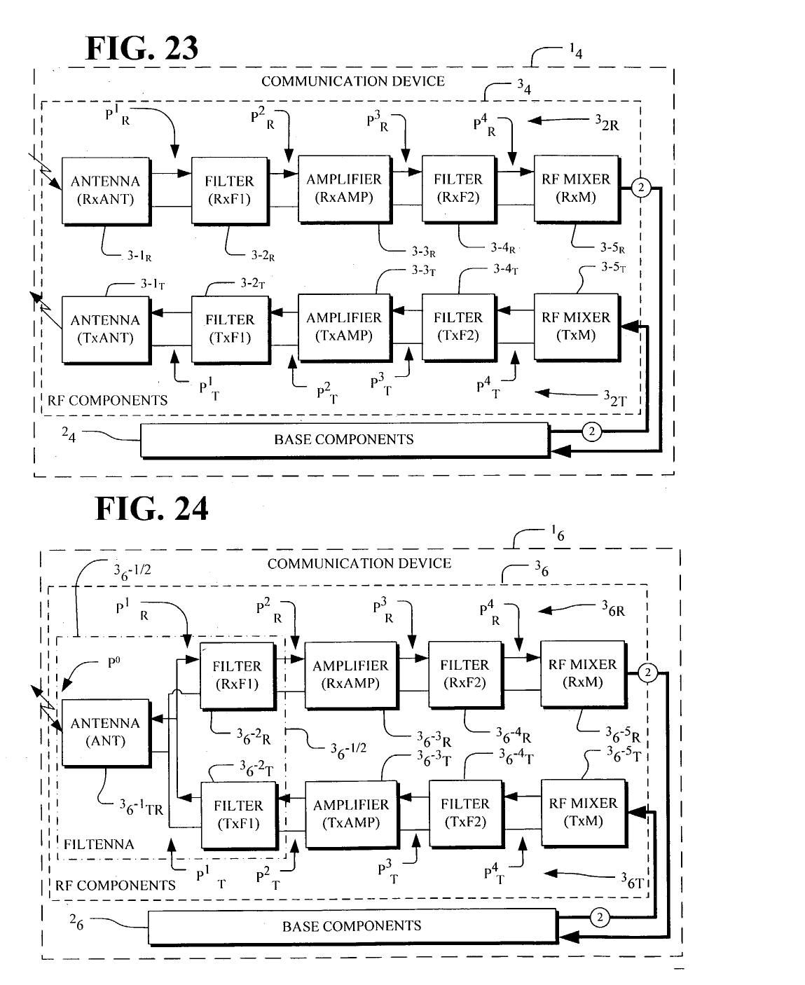

FIG. 23 depicts a schematic view of a small communication device with RF front-end functions that benefit from antennas described in the present specification. The small communication device includes separate transmit and receive antennas, filters and other RF function components and lower frequency base components incorporating the antennas described in various embodiments. In FIG. 23, the small communication device 14 includes RF front-end components 3₄ and base components 2₄. The RF components perform the RF front-end functions and have both a receive path 3_{2R} and a transmit path 3_{2T}. The receive path 3_{2R} includes an antenna function 3-1_{R}, which typically employs the antenna of FIG. 14, a filter function 3-2_{R}, an amplifier function 3-3_{R}, a filter function 3-4_{R} and a mixer function 3-5_{R}. The antenna function 3-1_{R} is for converting between received radiation and electronic signals, the filter function 3-2_{R} is for limiting signals within an operating frequency band for the receive signals, the amplifier function 3-3_{R} is for boosting receive signal power, the filter function 3-4_{R} is for limiting signals within the operating frequency receive band, and the mixer function 3-5_{R} is for shifting frequencies between RF receive signals and lower frequencies.

The transmit path 3_{2R} includes a mixer function 3-5_{T}, a filter function 3-4_{T}, an amplifier function 3-3_{T}, a filter function 3-2_{T}, and an antenna function 3-1_{T}, which typically employs the antenna of FIG. 15. The mixer function 3-5_{T} is for shifting frequencies between lower frequencies and RF transmit signals, the filter function 3-4_{T} is for limiting signals within the operating frequency transmit band, the amplifier function 3-3_{T} is for boosting transmit signal power, the filter function 3-2_{T} is for limiting signals within operating frequency band for the transmit signals, and the antenna function 3-1_{T} is for converting between electronic signals and the transmitted radiation.

In FIG. 23, the RF front-end functions are connected by junctions. The junction P¹_{R} is between antenna function 3-1_{TR} and filter functions 3-2_{R}, the junction P²_{R} is between filter function 3-2_{R} and the amplifier function 3-3_{R} the junction p³_{R} is between amplifier function 3-3_{R} and filter function 3-4_{R} and the junction p⁴_{R} is between filter function 3-4_{R} and mixer function 3-5_{R}. The junction P¹_{T} is between antenna function 3-1_{T} and filter functions 3-2_{T}, the junction P²_{T} is between filter function 3-2_{T} and the amplifier function 3-3_{T}, the junction P³_{T} is between amplifier function 3-3_{T} and filter function 3-4_{T} and the junction P⁴_{T} is between filter function 3-4_{T} and mixer function 3-5_{T}.

In the embodiment of FIG. 23, the junctions P¹_{R}, P²_{R}, P³_{R} and P⁴_{R} correspond to ports of the filter 3-2_{R} amplifier 3-3_{R}, filter 3-4_{R} and mixer 3-5_{R} components and the junctions P⁴_{T}, P³_{T}, P²_{T} and P²_{T} correspond to ports of mixer 3-5_{T}, filter 3-4_{T}, amplifier 3-3_{T} and filter 3-4_{T} components.

FIG. 24 depicts a schematic view of a small communication device with RF front-end functions including a common antenna for transmitting and receiving and separate filter and other RF function components for transmitting and receiving and including lower frequency base components incorporating antennas described in various embodiments.

In FIG. 24, the small communication device 16 includes RF front-end components 3₆ and base components 2₆. The RF components perform the RF front-end functions and have both a receive path 3_{6R} and a transmit path 3_{6T}. The receive path 3_{6R} includes common antenna function 3₆-1_{TR}, a filter function 3₆-2_{R}, an amplifier function 3₆-3_{R}, a filter function 3₆-3_{R} and a mixer function 3₆-5_{R}. The antenna function 3₆-1_{TR} is for converting between received radiation and electronic signals, the filter function 3₆-2_{R} is for limiting signals within an operating frequency band for the receive signals, the amplifier function 3₆-3_{R} is for boosting receive signal power, the filter function 3₆-4_{R} is for limiting signals within the operating frequency receive band, and the mixer function 3₆-5_{R} is for shifting frequencies between RF receive signals and lower frequencies.

The transmit path 3_{6T} includes a mixer function 3₆-5_{T}, a filter function 3₆-4_{T}, an amplifier function 3₆-3_{T} and common antenna function 3₆-1_{TR}, a filter function 3₆-2_{T}, and an antenna function 3₆-1_{TR}. The mixer function 3₆-5_{T} is for shifting frequencies between lower frequencies and RF transmit signals, the filter function 3₆-5_{T} is for limiting signals within the operating frequency transmit band, the amplifier function 3₆-3_{T} is for boosting transmit signal power, the filter function 3₆-2_{T} is for limiting signals within operating frequency band for the transmit signals, and the antenna function 3₆-1_{TR} is for converting between electronic signals and transmitted radiation.

In FIG. 24, the RF front-end functions are connected by junctions. The junction P¹_{R} is between antenna function 3₆-1_{TR} and filter functions 3₆-2_{R}, the junction P²_{R} is between filter function 3₆-2_{R}, and the amplifier function 3₆-4_{R}, the junction P³_{R} is between amplifier function 3₆-3_{R} and filter function 3₆-4_{R} and the junction P⁴_{R} is between filter function 3₆-4_{R} and mixer function 3₆-5_{R}. The junction P¹_{T} is between antenna function 3₆-1_{TR} and filter function 3₆-2_{T}, the junction P²_{T} is between filter function 3₆-2_{T} and the amplifier function 3₆-3_{T}, the junction P³_{T} is between amplifier function 3₆-3_{T} and filter function 3₆-4_{T} and the junction P⁴_{T} is between filter function 3₆-4_{T} and mixer function 3₆-5_{T}.

In the embodiment of FIG. 24, the junctions P¹_{R}, P²_{R}, P³_{R} and P⁴_{R} correspond to ports of filter 3₆-2_{R}, amplifier 3₆-3_{R}, filter 3₆-4_{R} and mixer 3₆-5_{R} and the junctions P⁴_{T}, P³_{T}, P²_{T} and P¹_{T} correspond to ports of mixer 3₆-5_{T}, filter 3₆-4_{T}, amplifier 3₆-3_{T} and filter 3₆-2_{T}. The antenna function 3₆-1_{TR} and the filter functions 3₆-2_{R} and 3₆-2_{T} in one embodiment are in a common antenna/filter unit 3₆-½.

While the invention has been particularly shown and described with reference to preferred embodiments thereof it will be understood by those skilled in the art that various changes in form and details may be made therein without departing from the scope of the invention.

1. (original) an antenna, for use with a communication device operating for exchanging energy in one or more bands of radiation frequencies, comprising,
a radiation element for operating in said one or more bands, said element including,
a plurality of conducting segments electrically connected to exchange energy in said one or more bands of radiation frequencies,
said segments arrayed in a compressed pattern,
said compressed pattern extending in three dimensions to fill a volume with segments superimposed in the volume to reduce the size of a projection of the antenna on a base plane of the volume.

2. (Original) The antenna of claim 1 wherein said radiation element are deployed on a flexible substrate and said element and said substrate are folded to fit within said volume.

3. (Original) The antenna of claim 1 wherein said radiation element is deployed in regions having sections of the radiation element and is deployed on a flexible substrate where said element and said substrate are folded to fit within said volume and wherein said sections are separated by dielectric spacers.

4. (Original) The antenna of claim 1 wherein said radiation element is arrayed to form a loop.

5. (Original) The antenna of claim 1 wherein said radiation element includes one or more connection pads for electrical connection of the radiation element to RF components of said communication device.

6. (Original) The antenna of claim 1 wherein said radiation element terminates in connection pads for surface mounting to a circuit board.

7. (Original) The antenna of claim 1 wherein said bands include a US PCS band operating from 1850 MHz to 1990 MHz, a European DCS band operating from 1710 MHz to 1880 MHz, a European GSM band operating from 880 MHz to 960 MHz and a US cellular band operating from 829 MHz to 896 MHz.

8. (Original) The antenna of claim 1 wherein said element is deployed on a substrate folded to fit within said volume.

9. (Original) The antenna of claim 1 wherein said radiation element is formed by sections with each section having electrically connected conducting segments.

10. (Original) The antenna of claim 9 wherein said sections are deployed on one side of a common substrate.

11. (Original) The antenna of claim 10 wherein said radiating element is a loop.

12. (Original) The antenna of claim 9 wherein said sections are deployed on both sides of a common substrate.

13. (Original) The antenna of claim 1 wherein said segments are arrayed in multiple divergent directions not parallel to an orthogonal coordinate system so as to provide a long antenna electrical length while permitting the overall outside dimensions of said antenna to fit within said volume.

14. (Original) The antenna of claim 1 wherein said radiation element includes connection pads for coupling to a transceiver unit of said communication device and for connection to another radiation element.

15. (Original) The antenna of claim 1 wherein said radiation element has an irregular shape and wherein said segments are arrayed in an irregular three-dimensional compressed pattern.

16. (Original) The antenna of claim 1 wherein said radiation elements transmit and receive radiation.

17. (Original) The antenna of claim 1 wherein said radiation element transmits and receives in the US PCS band operating from 1850 MHz to 1990 MHz.

18. (Original) The antenna of claim 1 wherein said radiation element transmits and receives in a European DCS band operating from 1710 MHz to 1880 MHz.

19. (Original) The antenna of claim 1 wherein said radiation element transmits and receives in a European GSM band operating from 880 MHz to 960 MHz.

20. (Original) The antenna of claim 1 wherein said radiation element transmits and receives in a US cellular band operating from 829 MHz to 896 MHz.

21. (Original) The antenna of claim 1 wherein said radiation element transmits and receives in mobile telephone frequency bands anywhere from 800 MHz to 2500 MHz.

22. (Original) The antenna of claim 1 wherein said radiation element is on a first layer mounted on dielectric material and where another radiation element is on a second layer mounted on dielectric material where said first and second layers are juxtaposed.

23. (Original) The antenna of claim 1 wherein said radiation element provides multi-band performance.
